(19) United States
(12) Patent Application Publication
(10) Pub. No.: US 2007/0029705 A1
(43) Pub. Date: Feb. 8, 2007

(54) Apparatus and method for injection molding

(76) Inventors: Ching-Chang Wang, Tu-Cheng City (TW); Chih-Yu Chen, Tu-Cheng City (TW)

Correspondence Address: LIN & ASSOCIATES INTELLECTUAL PROPERTY, P.O. BOX 2339, SARATOGA, CA, 95070-0339, US

(21) Appl. No.: 11/194,948

(22) Filed: Aug. 2, 2005

(51) Int. Cl. B29C 45/00

(52) U.S. Cl. 264/328.7; 264/328.16; 425/547

(57) ABSTRACT

An injection molding apparatus includes a set of injection moulds and a set of cooling moulds. The set of injection moulds include a male injection mould and a female injection mould that are closed together to define an injection mould cavity. The set of cooling moulds include a male cooling mould and a female cooling mould that are closed together to define a cooling mould cavity. Molten plastic material is injected into the injection mould cavity to form a plastic article. The male injection mould and the male cooling mould are identical and interchangeable to enable the plastic article to be transferred to the cooling moulds. While the plastic article is accommodated in the cooling mould cavity and being cooled therein, molten plastic article is injected again into the injection mould cavity to form another plastic article. Thereby, the injection molding cycle time is reduced and the efficiency is improved.

### BACKGROUND OF THE INVENTION

1. Field of the Invention

The present invention relates generally to an apparatus and a method of an injection molding, and more especially to an apparatus and a method for injection molding wherein cycle time is reduced.

2. The Related Art

At present, in the field of manufacturing thermoplastic articles, injection molding is widely applied, because the manufacture cost is low, the molding process is easy to control and also easy to form plastic articles with complex shapes.

Conventionally, an injection molding mould comprises a male mould, a female mould and a blanking plate. The male and female moulds are combined together to define a mould cavity. The blanking plate is employed to scrap off plastic remainders. According to the prior art, the method for injection molding comprises the following steps of: (1) injecting molten plastic material into the mould cavity to form a plastic article; (2) cooling the plastic article molded in the mould cavity; (3) opening the male mould and the female mould; (4) taking the plastic article out from the mould cavity; and (5) closing the male mould and the female mould, then repeating the above steps to form another plastic article.

However, in the total molding cycle time to form a plastic article using the conventional injection molding mould and the conventional method mentioned above, the time of cooling the plastic article takes about 30 percent. As a result, the method and the injection molding mould mentioned above are time-consuming and low efficiency.

### SUMMARY OF THE INVENTION

It is an object of the present invention to provide an injection molding apparatus for reducing cycle time. The injection molding apparatus comprises a set of injection moulds and a set of cooling moulds. The set of injection moulds include a male injection mould and female injection mould. An injection mould cavity is defined between the male and female injection moulds when the male and female injection moulds are closed together for forming a plastic article. The set of cooling moulds include a male cooling mould and a female cooling mould. A cooling mould cavity is defined between the male and female cooling moulds when the male and female cooling moulds are closed together for accommodating the plastic article and cooling the plastic article therein. The male injection mould and the male cooling mould are identical. So the male injection mould and the male cooling mould are interchangeable to enable the plastic article moulded by the injection moulds to be transferred to the cooling moulds. While the plastic article is being cooled in the cooling mould cavity, the injection moulds form another plastic article.

It is another object of the present invention to provide a method of injection molding using the injection molding apparatus mentioned above. The method comprises the following steps: (1) injecting molten plastic material into the injection mould cavity to form a plastic article; (2) opening the injection moulds and the cooling moulds respectively; (3) interchanging the male injection mould and the male cooling mould together with the plastic article; (4) closing the cooling moulds and the injection moulds respectively; (5) injecting molten plastic material into the injection mould cavity again to form another plastic article; (6) opening the cooling moulds to take out the plastic article from the cooling mould cavity and opening the injection moulds; and (7) interchanging the male injection mould and the male cooling mould again together with the new-moulded plastic article, then repeating the steps from step (4) to step (7).

As mentioned above, while the plastic article is being cooled in the cooling moulds, molten plastic material is injected into the injection mould moulds to form a next plastic article. Thus, the total injection molding cycle time is reduced, and the efficiency of injection molding is improved.

### BRIEF DESCRIPTION OF THE DRAWINGS

The above-mentioned and other features and objects of this invention and the manner of attaining them will become more apparent and the invention itself will be better understood by reference to the following description of a preferred embodiment of the invention taken in conjunction with the accompanying figures wherein:

FIG. 1 is a perspective view of an injection molding apparatus including a set of injection moulds and a set of cooling moulds according to the present invention;

FIG. 2 is a cross-sectional view of the injection molding apparatus shown in FIG. 1; and

FIGS. 3 to 7 depict procedural steps in forming plastic articles using the injection molding apparatus shown in FIG. 1.

### DETAILED DESCRIPTION OF THE PREFERRED EMBODIMENT

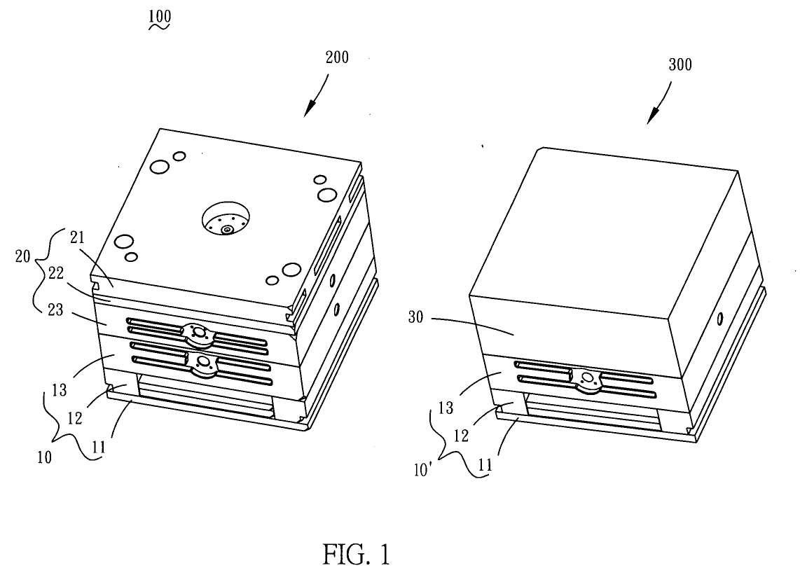

With reference to FIG. 1, an injection molding apparatus 100 in accordance with the present invention comprises a set of injection moulds 200 and a set of cooling moulds 300.

The set of injection moulds 200 comprises a male injection mould 10 and a female injection mould 20. The female injection mould 20 is disposed above the male injection mould 10. The set of cooling moulds 300 comprises a male cooling mould 10′ and a female cooling mould 30. The female cooling mould 30 is positioned above the male cooling mould 10′.

The male injection mould 10 and the male cooling mould 10′ are identical so as to be interchangeable. Each of the male injection mould 10 and the male cooling mould 10′ comprises a lower fixed plate 11, a spaced plate 12 and a male plate 13. The spaced plate 12 is disposed above the lower fixed plate 11 and fixed thereon. The male plate 13 is fixed on the spaced plate 12. The female injection mould 20 comprises an upper fixing plate 21, a blanking plate 22 and a female plate 23. The blanking plate 22 is located between the upper fixing plate 21 and the female plate 23.

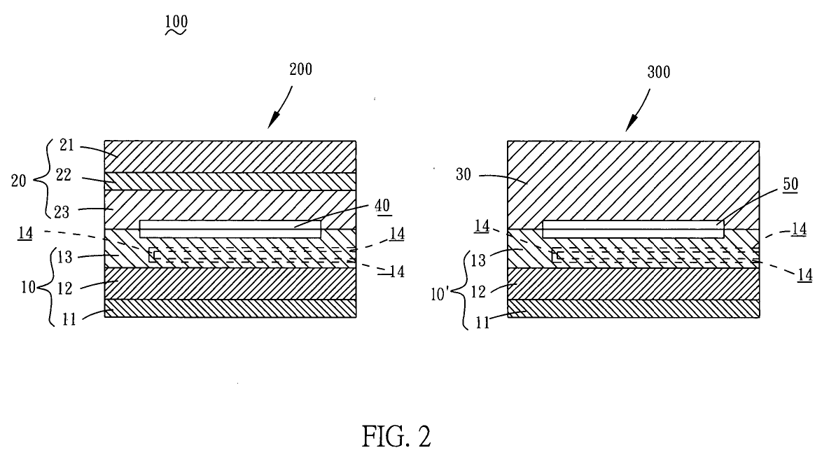

Referring to FIG. 2, each of the male injection mould 10 and the male cooling mould 10′ has a cooling system formed in the male plate 13. The cooling system consists of a plurality of water-cycled cooling runners 14 for cooling water flowing therein. An injection mould cavity 40 is defined between the male plate 13 and the female plate 23 when the male and female injection moulds 10, 20 are closed together. Molten plastic material is injected into the injection mould cavity 40 for forming a plastic article therein. A cooling mould cavity 50 is defined between the male plate 13 of the male cooling mould 10′ and the female cooling mould 30 when the male and female cooling moulds 10′, 30 are closed together. The male injection mould 10 and the male cooling mould 10′ are interchanged so as to enable the plastic article to be transferred to the cooling mould cavity 50. Thus, the cooling water in the water-cycled cooling runners 14 cools the plastic article accommodated in the cooling mould cavity 50, and simultaneously, plastic material is injected again into the injection mould cavity 40 to form another plastic article.

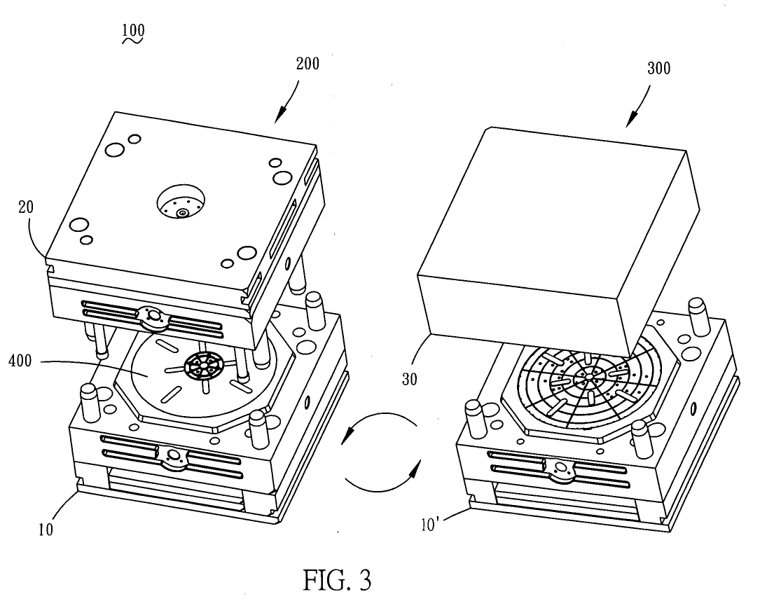

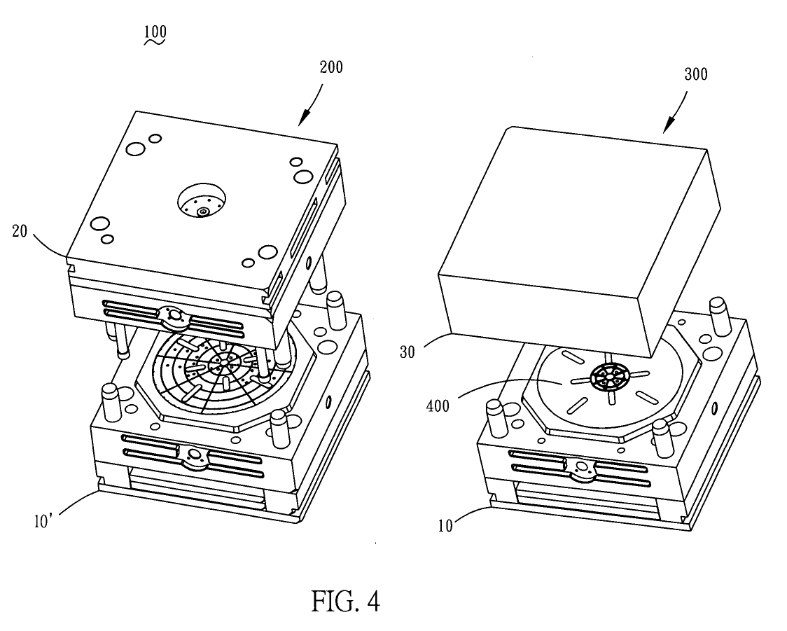

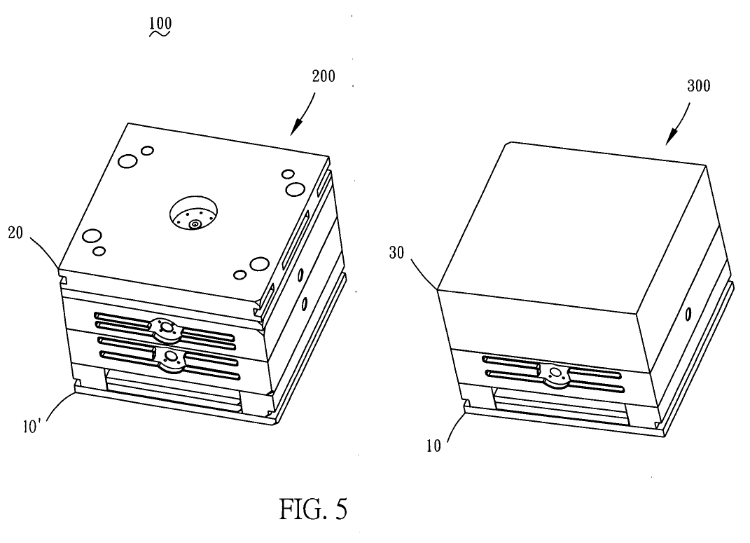

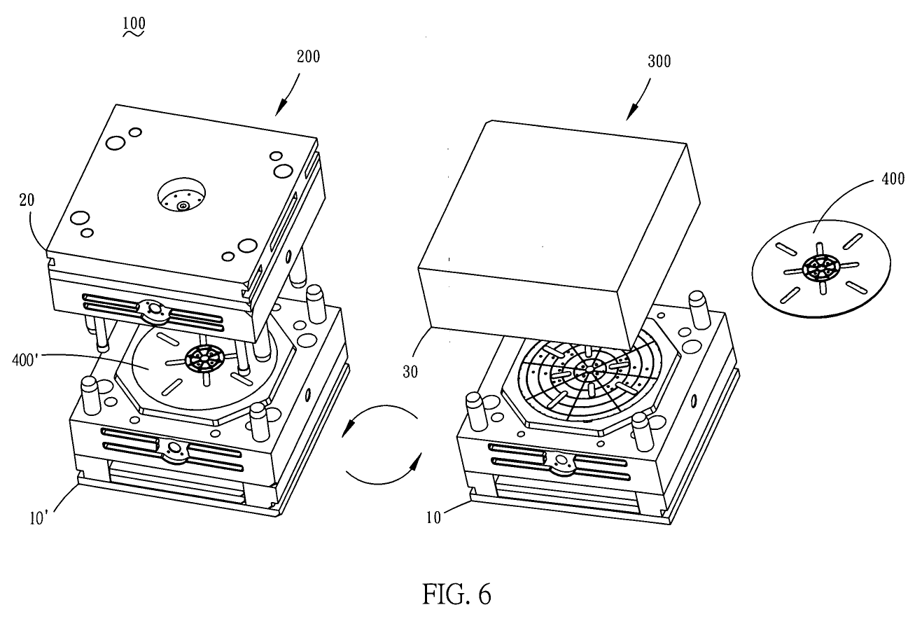

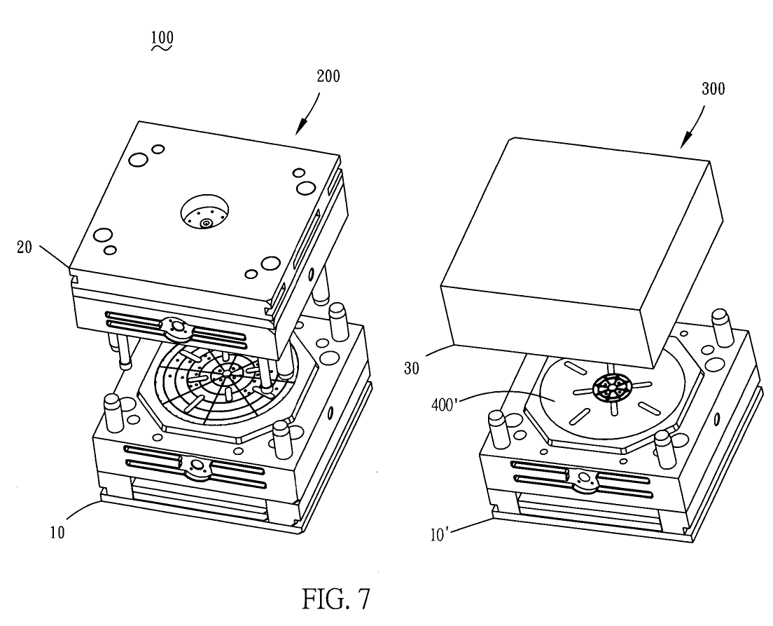

Now referring to FIG. 3 to FIG. 7 in conjunction with FIG. 1, a method for injection molding using the injection molding apparatus 100 mentioned above comprises the following steps: (1) as shown in FIG. 1, injecting molten plastic material into the injection mould cavity 40; (2) as shown in FIG. 3, opening the injection moulds 200 with a plastic article 400 being molded in the injection mould cavity 40, during which the blanking plate 22 blanks out plastic remainders from the plastic article 400, and opening the cooling moulds 300; (3) as illustrated in FIG. 4, interchanging the male injection mould 10 and the male cooling mould 10′ together with the plastic article 400 so that the plastic article 400 is transferred to the cooling mould cavity 50; (4) as shown in FIG. 5, closing the injection moulds 200 and the cooling moulds 300 respectively, while the cooling system 14 of the cooling moulds 300 is cooling the plastic article 400, injecting molten plastic material again into the injection mould cavity 40 to form another plastic article 400′; (5) referring to FIG. 6, opening the injection moulds 200 with the new-moulded plastic article 400′ and the cooling moulds 300 respectively, taking out the plastic article 400 from the cooling mould cavity 50; (6) as illustrated in FIG. 7, interchanging the male injection mould 10 and the male cooling mould 10′ again together with the new-molded plastic article 400′ so that the new-molded plastic article 400′ is transferred to the cooling mould cavity 50 for being cooled therein, and then repeating the step (4) to step (6).

As described above, in the present invention, the set of cooling moulds 300 are used to cool the precious plastic article 400 while the molten plastic material is injected into the injection mould cavity 40 to form another plastic article, thus to reduce the injection molding cycle time. The male injection mould 10 and the male cooling mould 10′ are identical so as to be interchangeable used to cooperate with either the injection moulds 200 or cooling moulds 300. So the molding cycle time is reduced and the efficiency is improved.

Accordingly, there has been disclosed an improved injection molding apparatus and a method for reducing injection molding cycle time. While an illustrate embodiment of this invention has been disclosed herein, it is understood that various modifications and adaptations to the disclosed embodiments are possible, and it is intended that this invention be limited only by the scope of the appended claims.

What is claimed is:

1. An injection molding apparatus, comprising:
a set of injection moulds including a male injection mould and a female injection mould, an injection mould cavity being defined between the male and female injection moulds when the male and female injection moulds are closed together for forming a plastic article therein; and
a set of cooling moulds including a male cooling mould and a female cooling mould, a cooling mould cavity being defined between the male and female cooling moulds when the male and female cooling moulds are closed together for accommodating the moulded plastic article and cooling the plastic article therein;
wherein the male injection mould and the male cooling mould are identical so that the male injection mould and the male cooling mould are interchangeable to enable the plastic article moulded by the injection moulds to be transferred to the cooling moulds, and while the plastic article is being cooled, the injection moulds form another plastic article.

2. The injection molding apparatus as claimed in claim 1, wherein each of said male injection mould and said male cooling mould comprises a male plate, a spaced plate, and a lower fixed plate.

3. The injection molding apparatus as claimed in claim 2, wherein the female injection mould comprises a female plate, a blanking plate, and an upper fixed plate.

4. A method for injection molding using the injection molding apparatus claimed as claim 1, comprising the steps of:
(1) injecting molten plastic material into the injection mould cavity to form a plastic article;
(2) opening the injection moulds and the cooling moulds respectively;
(3) interchanging the male injection mould and the male cooling mould together with the plastic article;
(4) closing the cooling moulds and the injection moulds respectively;
(5) injecting molten plastic material into the injection mould cavity again to form another plastic article;
(6) opening the cooling moulds to take out the plastic article from the cooling mould cavity and opening the injection moulds; and
(7) interchanging the male injection mould and the male cooling mould again together with the new-moulded plastic article, then repeating the steps from step (4) to step (7).
